(19) United States
(12) Patent Application Publication
(10) Pub. No.: US 2014/0337704 A1
(43) Pub. Date: Nov. 13, 2014

(54) SYSTEM AND METHOD FOR CONVERTING BETWEEN DATA FORMATS

(71) Applicant: HON HAI PRECISION INDUSTRY CO., LTD., New Taipei (TW)

(72) Inventors: SHAO-YOU TANG, New Taipei (TW); PO-CHUAN HSIEH, New Taipei (TW); WEI-CHIEH CHOU, New Taipei (TW)

(73) Assignee: HON HAI PRECISION INDUSTRY CO., LTD., New Taipei (TW)

(21) Appl. No.: 14/273,554

(22) Filed: May 9, 2014

(30) Foreign Application Priority Data
May 10, 2013 (TW) 102116664

(51) Int. Cl. G06F 17/24; G06F 17/30

(52) U.S. Cl. CPC G06F 17/246; G06F 17/30076
USPC 715/219

(57) ABSTRACT

A system and a method for converting between data formats converts air flow data from a thermal simulation tool into a format readable by a DC power analyzing tool. Air flow data associated with the locations of certain points on a printed circuit board are taken and an EXCEL document including Main, Data, and Final worksheets is created. The data to be converted is obtained, and the data imported into the Data worksheet. Parameters in the Main worksheet to set an analysis area of the printed circuit board are set, and air flow data associated with the analysis areas from the Data worksheet are obtained and divided into groups, according to the parameters set in the Main worksheet. An equivalence value for each group of data is calculated and the equivalence values are saved in the Final worksheet for reading by the DC power analyzing tool.

### FIELD

The present disclosure relates to data format conversion technology, and particularly to a system and a method for converting between data formats.

### BACKGROUND

A lot of heat is generated when electronic devices work, and performance of the system of the electronic device is affected if no effective heat dissipation is provided. Some thermal simulation tools have been developed to calculate air flow required for heat dissipation, according to the heat generated in an interior of the electronic devices. FLOTHERM software developed by Mentor Graphic is one such thermal simulation tool.

After the air flow is calculated, DC power analysis is required, from which it can be determined whether the working voltage of electronic components of the electronic device reaches a rated voltage. POWERDC software developed by Cadence is one such DC power analysis tool which can perform DC power analysis. However, the format of air flow data (as shown in FIG. 1A) calculated by the FLOTHERM software is different from the data format (as shown in FIG. 1B) required by the POWERDC software. A format conversion for the air flow data calculated by the FLOTHERM software would be required before the air flow data could be imported into the POWERDC software for analyzing.

### BRIEF DESCRIPTION OF THE DRAWINGS

Many aspects of the embodiments described herein can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1A is a schematic diagram showing an example of air flow data calculated by FLOTHERM software.

FIG. 1B is a schematic diagram showing an example of air flow data required by POWERDC software.

FIG. 2 is a block diagram of one embodiment of an electronic device including a data format conversion system.

FIG. 3 is a flowchart illustrating a method for converting the format of air flow data.

FIG. 4 is a schematic diagram of an example of an EXCEL document created by the data format conversion system of FIG. 2, which includes a Main worksheet, a Data worksheet, and a Final worksheet.

FIG. 5 is a schematic diagram of the Main worksheet of FIG. 4.

FIG. 6 is a schematic diagram of the Data worksheet of FIG. 4.

FIG. 7A is a schematic diagram showing groups of data each group including one or more air flow data indicated by dots.

FIG. 7B is a schematic diagram showing groups of data including an equivalence value which is indicated by a dot.

FIG. 8 is a schematic diagram of the Final worksheet of FIG. 4.

FIG. 9 is a schematic diagram of an input interface of a DC power analyzing tool.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

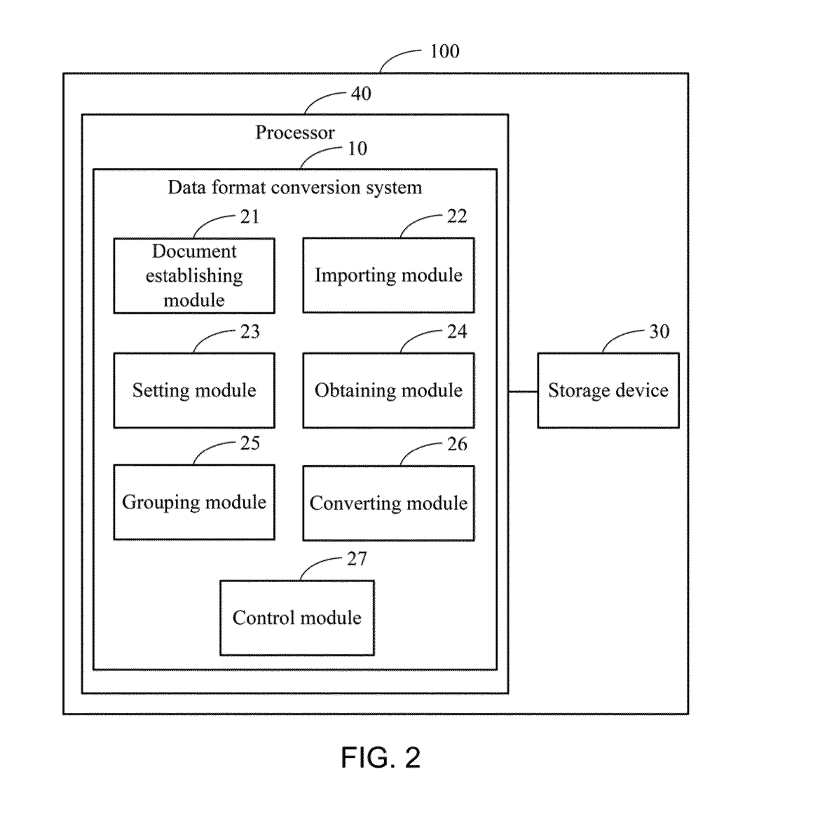

FIG. 2 illustrates a block diagram of one embodiment of an electronic device 100 including a data format conversion system 10. In the embodiment, the electronic device 100 further includes, but is not limited to, a storage device 30, and at least one processor 40. The electronic device 100 may be a computer or any other computing device.

The storage device 30 can store data, such as air flow data calculated by a thermal simulation tool. The at least one processor 40 can control the electronic device 100 to work and perform the data format conversion system 10.

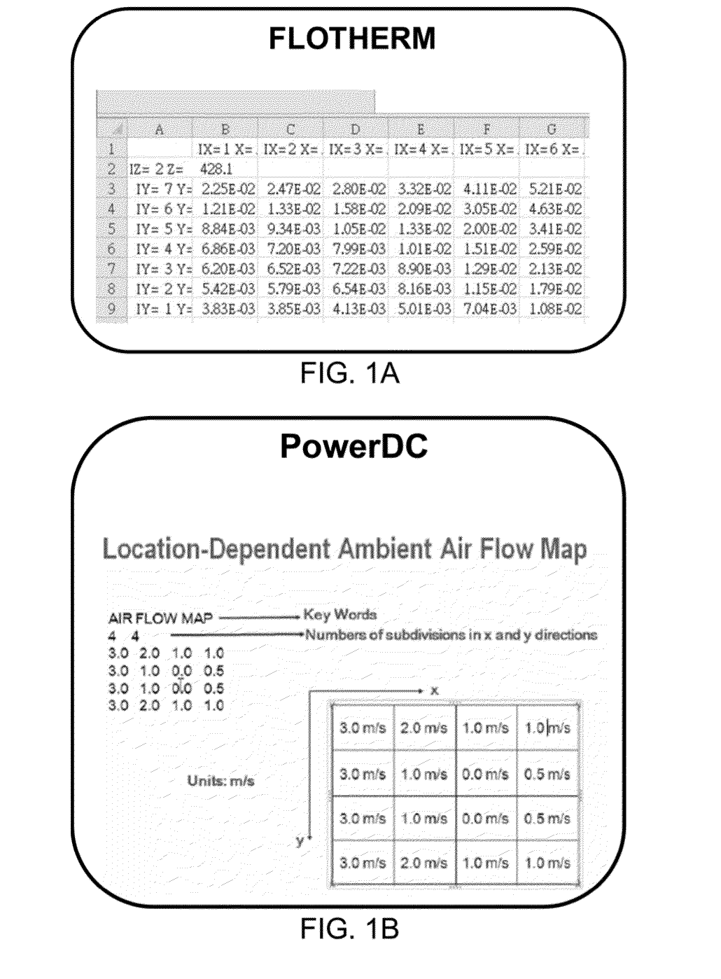

The data format conversion system 10 can convert format of the air flow data (as shown in FIG. 1A) calculated by a thermal simulation tool, into a format which can be read by a DC power analyzing tool. In one at least embodiment, the data format conversion system 10 can comprise computerized instructions in the form of one or more computer-readable programs stored in the storage device 30 and executed by the at least one processor 40.

In at least one embodiment, the data format conversion system 10 includes a document establishing module 21, an importing module 22, a setting module 23, an obtaining module 24, a grouping module 25, a converting module 26, and a control module 27.

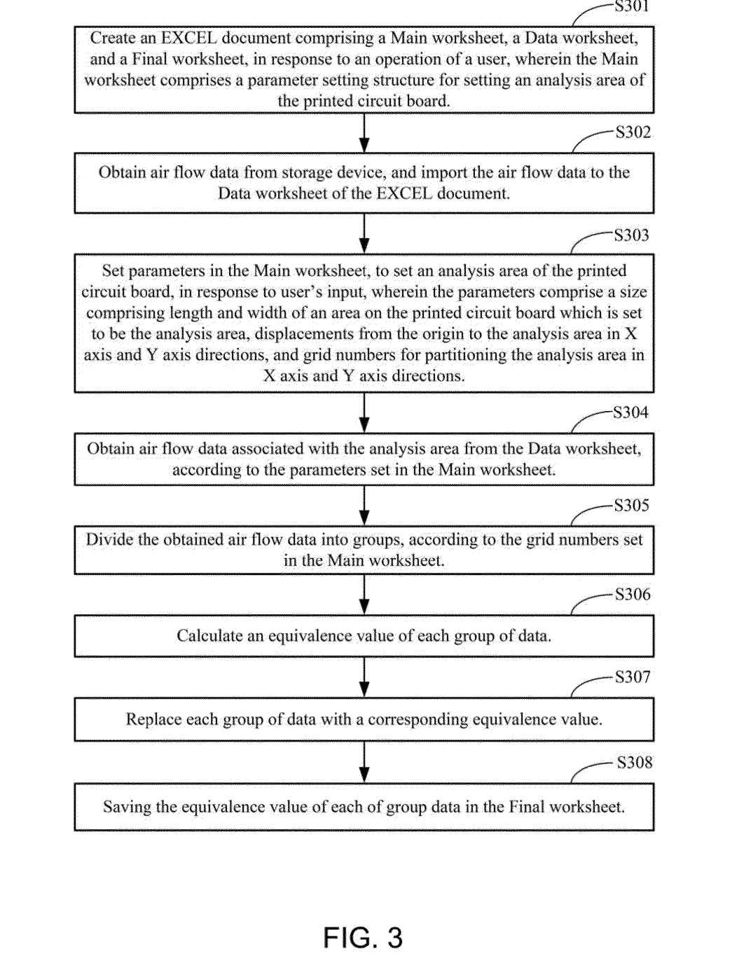

FIG. 3 is a flowchart illustrating a method executed by the electronic device 100 for converting the format of the air flow data. In the embodiment, the thermal simulation tool can be FLOTHERM software developed by Mentor Graphic, the DC power analyzing tool can be POWERDC software developed by Cadence.

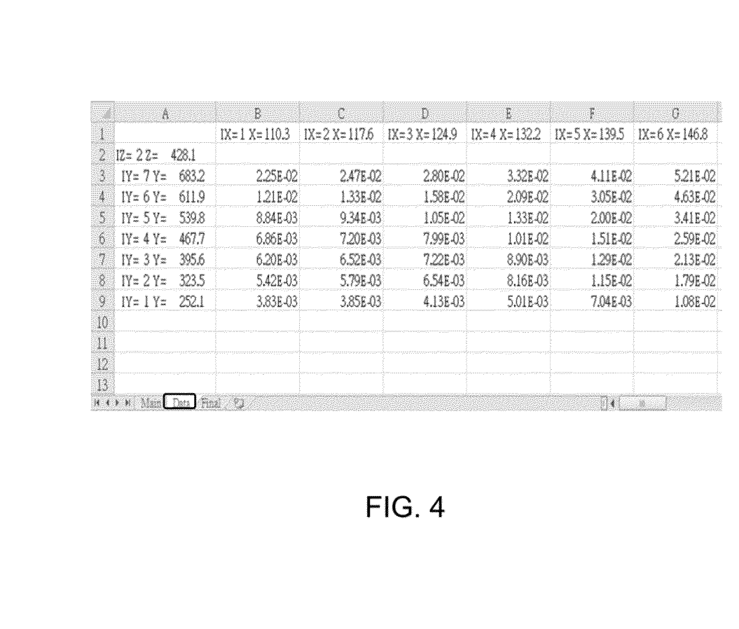

In 301, referring also to FIG. 4, the document establishing module 21 creates an EXCEL document including three worksheets in the EXCEL document in response to an operation of a user. In the embodiment, the three worksheets include a Main worksheet, a Data worksheet, and a Final worksheet.

In 302, the importing module 22 obtains the air flow data from the storage device 30, and imports the air flow data to the Data worksheet of the EXCEL document.

In the embodiment, each air flow data is associated with the location of a certain point on a printed circuit board.

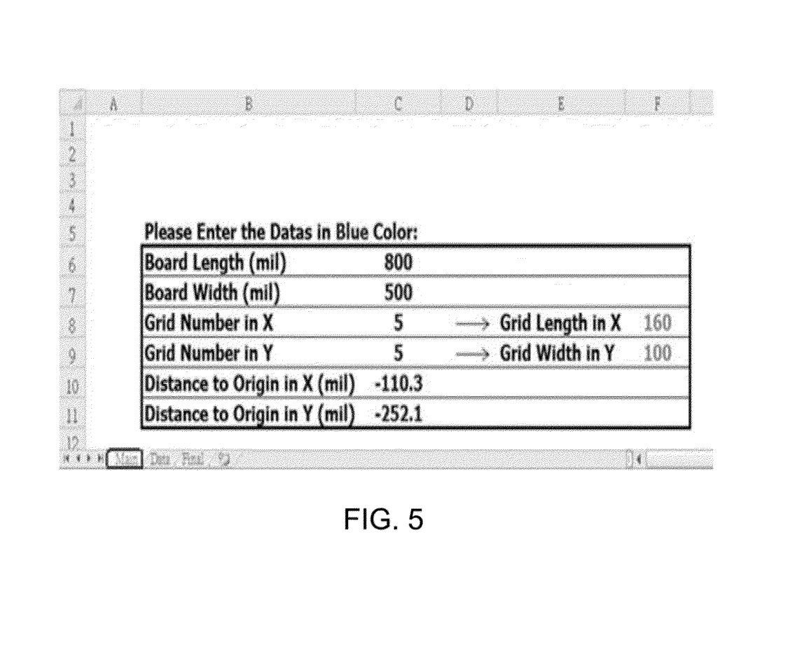

Referring also to FIG. 5, the Main worksheet includes a parameter setting structure for setting an analysis area of the printed circuit board.

In 303, the setting module 23 sets parameters in the Main worksheet, to set an analysis area of the printed circuit board, in response to user's input. In the embodiment, the parameters include a size including length and width of an area of the printed circuit board which is set to be the analysis area, displacements from the origin to the analysis area in X axis and Y axis directions, and grid numbers for partitioning the analysis area in X axis and Y axis directions.

For example, as shown in FIG. 5, the parameters of an analysis area are set as the length to be 800 mm, the width to be 500 mm, the displacements in X axis direction set to be −110.3, and the displacements in Y axis direction set to be −252.1 mm. The grid numbers in X axis direction are set to be 5, the grid numbers in Y axis direction are set to be 5, the grid length in X axis direction being set therefore to be 160 mm, and the grid width in Y axis direction is set to be 100 mm.

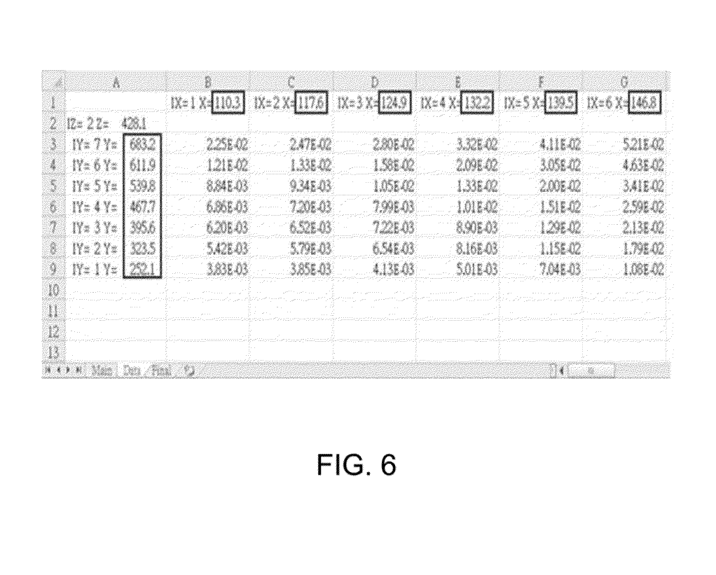

In 304, as shown in FIG. 6, the obtaining module 24 obtains air flow data associated with the analysis area from the Data worksheet, according to the parameters set in the Main worksheet. For example and for simplicity, only a portion of the obtained air flow data is shown in FIG. 6.

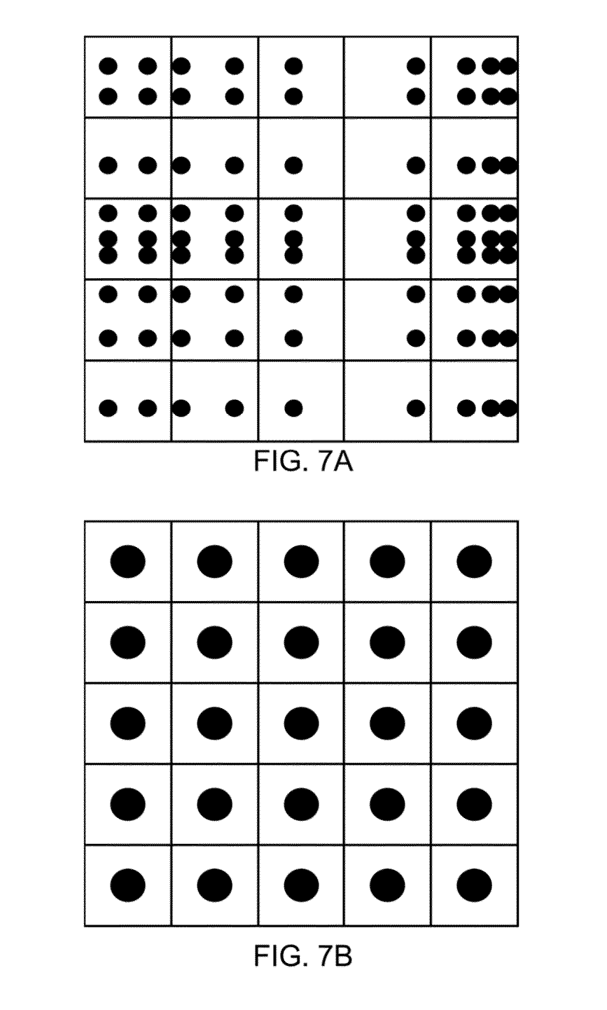

In 305, the grouping module 25 divides the obtained air flow data into groups, according to the grid numbers set in the Main worksheet. As shown in FIG. 7A, each group of data includes one or more air flow data each of which is indicated by a dot. The uneven distribution of the dots indicates that no air flow is detected on some points of the printed circuit board, which is shown by gaps between dots.

In 306, the converting module 26 calculates an equivalence value of each group of data. In the embodiment, the converting module 26 first calculates an average value and a standard deviation of each group of data, removes the data which has three standard deviations relative to the average value, and calculates an average value of the remaining data in the group, which can be defined to be the equivalence value of each group of data.

In 307, the converting module 26 replaces each group of data with a corresponding equivalence value. Therefore, as shown in FIG. 7B, each group of data includes only one data which is indicated by a dot.

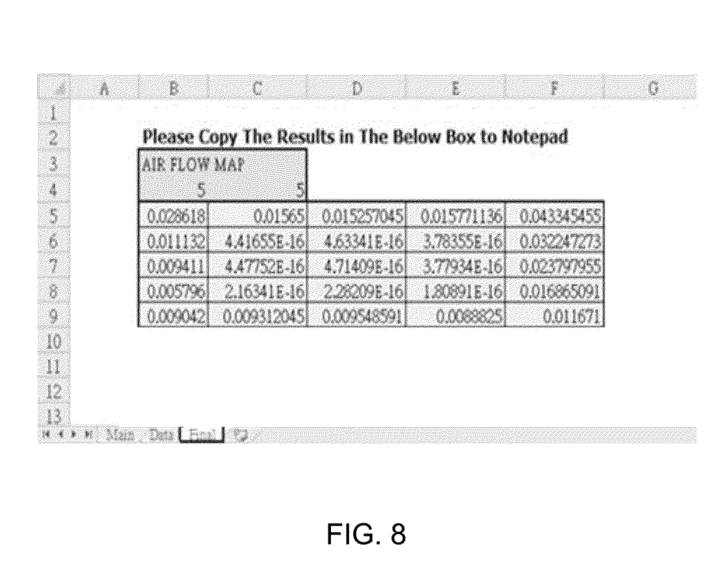

In 308, as shown in FIG. 8, the control module 27 saves the equivalence value of each group of data in the Final worksheet, and saves the Final worksheet as a text document.

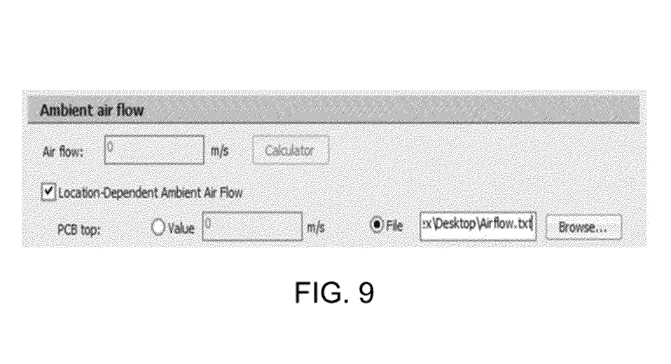

The format of air flow data calculated by the thermal simulation tool can be converted into a format which is required by the DC power analyzing tool, and can be imported into the DC power analyzing tool from an input interface as shown in FIG. 9.

It is to be understood that the foregoing disclosure may be embodied in other forms without departing from the scope thereof. Thus, the present examples and embodiments are to be considered in all respects as illustrative and not restrictive of the following claims.

What is claimed is:

1. A method for converting between data formats adapted for an electronic device, wherein the electronic device comprises a storage device for storing air flow data calculated by a thermal simulation tool, and wherein each one of the air flow data is associated with the location of a point on a printed circuit board, the method comprising:
creating an EXCEL document comprising a Main worksheet, a Data worksheet, and a Final worksheet, in response to an operation of a user, wherein the Main worksheet comprises a parameter setting structure for setting an analysis area of the printed circuit board;
obtaining the air flow data from the storage device, and importing the air flow data to the Data worksheet of the EXCEL document;
setting parameters in the Main worksheet, to set an analysis area of the printed circuit board, in response to user's input, wherein the parameters comprise a size comprising length and width of an area on the printed circuit board which is set to be the analysis area, displacements from the origin to the analysis area in X axis and Y axis directions, and grid numbers for partitioning the analysis area in X axis and Y axis directions;
obtaining air flow data associated with the analysis area from the Data worksheet, according to the parameters set in the Main worksheet;
dividing the obtained air flow data into groups, according to the grid numbers set in the Main worksheet;
calculating an equivalence value of each group of data; and
saving the equivalence value of each group of data in the Final worksheet.

2. The method as described in claim 1, wherein calculating an equivalence value of each group of data comprises:
calculating an average value and a standard deviation of each group of data;
removing the data which has a predetermined number of standard deviations relative to the average value; and
calculating an average value of the remaining data in the group, which is defined to be the equivalence value of each group of data.

3. A data format conversion system for an electronic device, wherein the electronic device comprises a storage device for storing air flow data calculated by a thermal simulation tool, and wherein each one of the air flow data is associated with the location of a point on a printed circuit board, the data format conversion system comprising:
at least one processors; and
a plurality of modules to be executed by the at least one processor, the modules comprising:
a document establishing module creating an EXCEL document comprising a Main worksheet, a Data worksheet, and a Final worksheet, in response to an operation of a user, wherein the Main worksheet comprises a parameter setting structure for setting an analysis area of the printed circuit board;
an importing module obtaining the air flow data from the storage device, and importing the air flow data to the Data worksheet of the EXCEL document;
a setting module setting parameters in the Main worksheet, to set an analysis area of the printed circuit board, in response to user's input, wherein the parameters comprise a size comprising length and width of an area on the printed circuit board which is set to be the analysis area, displacements from the origin to the analysis area in X axis and Y axis directions, and grid numbers for partitioning the analysis area in X axis and Y axis directions;
an obtaining module obtaining air flow data associated with the analysis area from the Data worksheet, according to the parameters set in the Main worksheet;
a grouping module dividing the obtained air flow data into groups, according to the grid numbers set in the Main worksheet;
a converting module calculating an equivalence value of each group of data; and
a control module saving the equivalence value of each group of data in the Final worksheet.

4. The system as described in claim 3, wherein the converting module first calculates an average value and a standard deviation of each group of data, removes the data which has a predetermined number of standard deviations relative to the average value, and calculates an average value of the remaining data in the group, which is defined to be the equivalence value of each group of data.
